(19) United States
(12) Patent Application Publication
(10) Pub. No.: US 2025/0313133 A1
(43) Pub. Date: Oct. 9, 2025

(54) METHOD FOR PRODUCING A SEAT ADJUSTMENT FOR A VEHICLE SEAT, GEAR COVER, SEAT ADJUSTMENT AND VEHICLE SEAT

(71) Applicant: Brose Fahrzeugteile SE & Co. Kommanditgesellschaft, Coburg, Coburg (DE)

(72) Inventors: Rene SCHEEDE, Bamberg (DE); Jochen HOFMANN, Marktgraitz (DE)

(21) Appl. No.: 19/245,874

(22) Filed: Jun. 23, 2025

Related U.S. Application Data
(63) Continuation of application No. PCT/EP2023/086964, filed on Dec. 20, 2023.

(30) Foreign Application Priority Data
Dec. 21, 2022 (DE) 10 2022 214 219.5

(51) Int. Cl. B60N 2/02; B60N 2/06; F16H 57/02; F16H 57/025

(52) U.S. Cl. CPC B60N 2/02258; B60N 2/067; F16H 57/025; F16H 2057/02034; F16H 2057/02082

(57) ABSTRACT

A method for producing a seat adjustment for a vehicle seat includes providing a gearing assembly with an electric motor, a gearwheel and a gear housing having a motor receptacle for receiving the electric motor and a cylindrical gearwheel receptacle for enclosing the gearwheel. A gear cover closes the gearwheel receptacle. During assembly of the gearing assembly, the gear cover is prefixed on the gearwheel receptacle, the gearing assembly is subsequently mounted in a motor support in such a manner that it sits at least in sections in the latter, and the gear cover is mechanically prevented by the motor support from being able to be detached from the gearwheel receptacle during operation. A gear cover, a seat adjustment and a vehicle seat are also provided.

### CROSS-REFERENCE TO RELATED APPLICATION

This application is a continuation, under 35 U.S.C. § 120, of copending International Patent Application PCT/EP2023/086964, filed Dec. 20, 2023, which designated the United States; this application also claims the priority, under 35 U.S.C. § 119, of German Patent Application DE 10 2022 214 219.5, filed Dec. 21, 2022; the prior applications are herewith incorporated by reference in their entirety.

### FIELD AND BACKGROUND OF THE INVENTION

The invention relates to a method for producing a seat adjustment for a vehicle seat, having a gearing assembly with an electric motor, a gearwheel and a gear housing which has a motor receptacle for receiving the electric motor and a cylindrical gearwheel receptacle for enclosing the gearwheel, and also a gear cover for closing the gearwheel receptacle. The invention further relates to a gear cover and to a seat adjustment and also to a vehicle seat.

The front vehicle seats in a motor vehicle, that is, in particular, the driver's seat, are typically configured to be longitudinally adjustable in the vehicle longitudinal direction (X) to enable vehicle users of various heights to conveniently operate the gas, brake and, if appropriate, clutch pedals. That is, such vehicle seats are horizontally adjustable forwards and backwards. For that purpose, the vehicle seats are coupled to a manual or electromotive seat adjustment, in particular a seat longitudinal adjustment.

Such a seat longitudinal adjustment has, as a guide, a rail arrangement with at least two seat rails (guide rails, longitudinal adjustment rails). Therein, the seat rails are also referred to as a (seat) upper rail and a (seat) lower rail, wherein the lower rail is fastened to the vehicle bottom in a stationary manner, and the upper rail coupled to the vehicle seat is bearing-mounted in the lower rail in a displaceable manner via guide elements.

Electromotive seat adjustments for motor vehicle seats are adjusted relatively slowly. The electric motors used for the drive, on the other hand, rotate relatively quickly, typically at up to 3000 revolutions per minute. For transmission of force, an adjusting gear is used which is adapted in such a way that a strong reduction takes place with the best possible efficiency to achieve the slow adjusting movement needed and also the required torque.

In the case of a seat longitudinal adjustment, a flexible (drive) shaft (known as a flex shaft) is conventionally used for transmission of force, which is disposed between an electric motor (seat longitudinal adjusting motor, adjusting motor) and an adjusting gear. For example, a seat longitudinal adjustment has two spindles fixed to the body, with a spindle nut seated on each of them, with the internal thread thereof engaging the external thread of the respective spindle. A drive worm coupled to the flex shaft engages external teeth of the spindle nut to rotatably drive the same and thus effect the adjustment of the spindle nut relative to the spindle. For example, the electric motor is bearing-mounted on the frame assembly or coupled to the upper rail to effect the adjustment of the upper rail or of the frame assembly relative to the lower rail.

The seat longitudinal adjustment ordinarily has two parallel rail arrangements which are disposed on both sides of the vehicle seat. Therein, it is possible, for example, for the electric motor to be disposed between the rail arrangements or upper rails by using a motor support. Therein, the electric motor is coupled, for example, via a gearing assembly, to two flex shafts extending towards the upper rails, each connected to an associated adjusting gear.

When assembling such a seat longitudinal adjustment, the joining of gear parts and later installation into a motor support are usually carried out separately from one another in separate assembly steps. Therein, the gear parts are typically already joined to a gearing assembly and fixed such that they can withstand the system requirements (axial and radial forces of the gear parts under load).

The gearing assembly has, for example, a gearwheel for drivingly coupling the electric motor to the two flex shafts, with the gearwheel disposed in a gearwheel receptacle. The gearwheel receptacle, which is pot-shaped, for example, is closed with a gear cover, wherein the bottom of the gearwheel receptacle and the gear cover each have a guide-through opening for a respective one of the flex shafts. Conventionally, the gear cover is joined firmly to the gearwheel receptacle during gear assembly, for example by using screw fastening or by using ultrasonic or laser welding.

### SUMMARY OF THE INVENTION

It is accordingly an object of the invention to provide a particularly suitable method for producing a seat longitudinal adjustment for a vehicle, a gear cover, a seat adjustment and a vehicle seat, which overcome the hereinafore-mentioned disadvantages of the heretofore-known methods and devices of this general type and which provide simplified assembly of a gearing assembly.

With the foregoing and other objects in view there is provided, in accordance with the invention, a method for producing a seat adjustment for a vehicle seat, having a gearing assembly with an electric motor and with a gearwheel and also with a gear housing which has a motor receptacle for receiving the electric motor and a cylindrical gearwheel receptacle for enclosing the gearwheel, and also a gear cover for closing the gearwheel receptacle, during assembly of the gearing assembly, the gear cover is prefixed on the gearwheel receptacle, the gearing assembly is subsequently mounted in a motor support in such a manner that it sits at least in sections in the latter, and the gear cover is mechanically prevented by the motor support from being able to be detached from the gearwheel receptacle during operation.

With the objects of the invention in view, there is also provided a gear cover for a gearing assembly of a seat adjustment, wherein the gear cover has a fastening device for prefixing on a gearwheel receptacle of the gearing assembly.

With the objects of the invention in view, there is furthermore provided a seat adjustment for a vehicle seat, having a gearing assembly and a motor support, the gearing assembly has an electric motor and a gearwheel and also a gear housing which has a motor receptacle for receiving the electric motor and a cylindrical gearwheel receptacle for enclosing the gearwheel, and also a gear cover according to the invention for closing the gearwheel receptacle, the gear cover is prefixed on the gearwheel receptacle, the gearing assembly sits at least in sections in the motor support, and the motor support mechanically prevents the gear cover from being able to be detached from the gearwheel receptacle during operation.

With the objects of the invention in view, there is concomitantly provided a vehicle seat for a motor vehicle, having a seat adjustment according to the invention.

Advantageous configurations and developments are the subject matter of the dependent claims. The advantages and configurations cited with respect to the method are also applicable analogously to the gear cover and/or the seat adjustment and/or the vehicle seat and vice versa.

The conjunction “and/or” is to be understood here and in the following in such a manner that the features linked by using this conjunction can be formed both jointly and as alternatives to one another.

Herein, the invention assumes a collective consideration of the joining processes of gear parts and their later installation into a motor support. The invention assumes the knowledge that, depending on the installation in the system/motor support, a joining process of gear parts which appears to be sensible when considered separately can become obsolete.

Herein, the method according to the invention is provided for producing a seat adjustment, for example a seat longitudinal adjustment, seat height adjustment or seat inclination adjustment, for a vehicle seat, for example a front seat, in particular a driver's seat, and is suitable and configured therefor.

According to the method, a gearing assembly is provided which has an electric motor as a (seat) adjusting motor and a gearwheel and also a gear housing. During operation, the electric motor, which is brushless, for example, drives a helical worm shaft, for example, which, in the assembled state, is in meshing engagement with the gearwheel, which is configured in particular as an externally toothed gearwheel. In the installed state, the gearwheel is coupled, for example, to one or two flex shafts, through the use of which the driving force of the electric motor is transmitted to a respective adjusting gear for longitudinal adjustment of the vehicle seat.

The gear housing of the gearing assembly has a motor receptacle for at least partially receiving the electric motor and a cylindrical gearwheel receptacle for enclosing the gearwheel, and also a gear cover for closing the gearwheel receptacle.

When assembling the gearing assembly, the gearwheel is inserted into the gearwheel receptacle, and the electric motor is disposed in the motor receptacle in such a manner that the electric motor is drivingly coupled to the gearwheel, in particular, herein, the driven worm shaft is brought into engagement with the gearwheel so that an electromotively driven worm gear drive is formed. According to the method, during such assembly of the gearing assembly, the gear cover is prefixed on or in the gearwheel receptacle.

Herein, “prefixed” or “prefixing” means preliminary retaining in the sense of preassembling. The joint connection realized thereby is provided regarding its stability, in particular only regarding transport and gear assembly, to prevent the gearwheel from falling or sliding out of the gearwheel receptacle which is undesired. The prefixed joint connection between the gear cover and the gearwheel receptacle is itself not provided or suitable for operating the gearing assembly under load. In this state of construction (preassembled state), the gear or the gearing assembly can thus not yet be operated under load according to the method.

After assembling the gearing assembly, the same is subsequently mounted in a motor support in such a manner that the gearing assembly is seated in sections in the motor support. According to the invention, the gear cover is mechanically prevented by the motor support from being able to be detached from the gearwheel receptacle during operation, that is, under (full) load. As a result, a particularly suitable method for producing a seat longitudinal adjustment is realized. In particular, process-saving assembly of gear parts is realized.

According to the invention, final fixing of the gearing assembly or of the gear cover is thus only carried out once it is in the motor support. The gear or the gearing assembly can only be operated under full system load once it is in the system since otherwise, the connection of the gear parts would not hold on its own due to the prefixing. In other words, the motor support is used to realize a reliable joint connection of the gear components. That is, in the production concept according to the invention, the gear assembly is combined with the assembly into the motor support. The motor support is thus extended by the additional function of reinforcing or fixing the mechanically comparatively weak joint connection of the prefixing.

Assembly in the motor support is carried out, for example, by sliding the gearing assembly into a gear receptacle of the motor support. Herein, the geometry of the motor support or of the gear receptacle ensures that the simple prefixing of the gear cover can no longer be detached. In particular, the gear cover is retained or fixed in a form-locking manner on the gearwheel receptacle by the motor support. After fixing in the motor support, the gearing assembly can withstand the system requirements. This means that the gearing assembly retained in the motor support is operable under (full) load without the gear cover being able to be detached from the gearwheel receptacle.

The method according to the invention eliminates an additional joining method (for example screw fastening, laser or ultrasonic welding) for permanently fixing the gear cover in or on the gearing assembly. Thus, the method according to the invention is particularly cost-effective and simple to perform.

With a corresponding receptacle in an assembly plant, despite the prefixing of the gear cover, an EOL test (EOL: End of Life) is still possible, for example, before installation into the motor support, to determine reliability and the technical limits of the gearing assembly. Herein, the receptacle of the assembly plant expediently likewise realizes form-locking retention of the gear cover on the gearwheel receptacle, and is formed, for example, to correspond to the gear receptacle of the motor support.

A “form lock” or a “form-locking connection” between at least two interconnected parts is understood here and in the following in particular to mean that the interconnected parts are held together at least in one direction by direct engagement of contours of the parts themselves or by indirect engagement via an additional connecting part. Any “blocking” of a reciprocal movement in this direction is thus conditioned by the form.

In an advantageous embodiment, the gear cover is prefixed in the gearwheel receptacle in a form-locking and/or force-locking manner. In particular, the gear cover is plug-mounted in the gearwheel receptacle in a form-locking and/or force-locking manner. As a result, a particularly simple and cost-effective prefixing for the gear cover is realized. In particular, additional structural parts or components for prefixing the gear cover to the gearwheel receptacle are thus eliminated. For example, the gear cover is merely plugged into or pressed onto the gearwheel receptacle. Simple form-locking and/or force-locking prefixing, for example in the form of scraper ribs molded thereon, a clip fastening (latching) or a threaded connection, reliably prevents the gearing assembly from falling apart during the gear assembly and transport.

A “force lock” or a “force-locking connection” between at least two interconnected parts is understood here and in the following in particular to mean that the interconnected parts are prevented from sliding off one another due to a frictional force acting between them. If a “connecting force” (meaning the force pushing the parts against one another, for example, a screw force or the weight force itself) eliciting this frictional force is absent, the force-locking connection cannot be maintained and can thus be detached.

The gear cover according to the invention is provided for the method described above and is suitable and configured therefor. Herein, the gear cover is configured for prefixing on a gearwheel receptacle of a gearing assembly of a seat adjustment. Herein, the gear cover has fastening devices through the use of which the gear cover is fastenable to the gearwheel receptacle. As a result, a particularly suitable gear cover is realized.

Since the fastening devices need only have sufficient stability for prefixing, the fastening devices are configurable in a comparatively simple and cost-effective manner. The fastening devices can be configured, for example, as a thread which is screwable into a corresponding mating thread of the gearwheel receptacle.

In an expedient development, the fastening devices or fasteners are in particular configured for form-locking and/or force-locking plug-in assembly. For example, the fastening devices for latching or clipping are configured as bendably flexible latching/clip lugs which, during the plug-in assembly, engage behind a mating contour of the gearwheel receptacle in a form-locking manner. As a result, particularly advantageous and cost-reduced prefixing is realizable.

In a preferred embodiment, the gear cover has a plug-in collar for plugging into the gearwheel receptacle, wherein scraper ribs projecting radially upwards are molded onto the plug-in collar as fastening devices. Herein, for prefixing with the scraper ribs, the gear cover is merely pressed into the gearwheel receptacle so that a form-locking and/or force-locking clamping fastening is realized as a joint connection between the gear cover and the gearwheel receptacle.

The seat adjustment according to the invention is provided for a vehicle seat, in particular for a front seat, for example for a driver's seat, and is suitable and configured therefor. Herein, the seat adjustment, which is configured as a seat longitudinal adjustment, for example, is produced in particular according to a method described above.

The seat adjustment has a gearing assembly and a motor support. The gearing assembly has an electric motor, a gearwheel, and a gear housing, wherein the gear housing has a motor receptacle for receiving the electric motor and a cylindrical gearwheel receptacle for enclosing the gearwheel, and also a gear cover described above for closing the gearwheel receptacle.

According to the invention, the gear cover is only prefixed on the gearwheel receptacle, wherein the gearing assembly sits at least in sections in the motor support in such a manner that the motor support mechanically prevents the gear cover from being able to be detached from the gearwheel receptacle during operation. Herein, the motor support preferably compensates for clearance between the gearing assembly and the motor support caused by structural part tolerances. As a result, a seat adjustment which is produceable in a particularly advantageous manner is realized.

In an advantageous embodiment, the motor support has a gear receptacle for the gearing assembly, in which the gearing assembly is disposed at least partially or in sections and which in doing so fixes the gear cover to the gearwheel receptacle in a form-locking and reliable manner. The gear receptacle in the motor support thus prevents the gear cover from falling out under system load.

For example, the motor support is configured as a single piece, that is, integrally or monolithically, wherein the gear receptacle is provided and configured in particular for sliding or plugging in the gearing assembly. Alternatively, the motor support can also be of multi-part configuration, wherein the motor support is assembled with the gear receptacle, for example, around the gearing assembly.

An additional or further aspect of the invention provides that the gearing assembly, in particular the gear housing, is fastened to the motor support in a form-locking and/or force-locking manner. As a result, the stability of the system is improved. For example, the gearing assembly is fixed in the motor support during assembly by a clip or a screw. Alternatively, the gearing assembly can also be fastened to the motor support in a material-locking manner, for example, by bonding or welding, for instance, in the region of a welding flange.

A “material lock” or a “material-locking connection” between at least two interconnected parts is understood here and in the following in particular to mean that the interconnected parts are held together at their contact surfaces by material combination or crosslinking (for example due to atomic or molecular bonding forces), if appropriate under the action of an additive.

In one possible embodiment, the gearing assembly, in particular the gear housing, is latched or clipped to the motor support. Herein, for example, several latching or clipping locations are provided for fastening the gearing assembly. However, only one latching or clipping location may be formed as well. As a result, particularly simple, stable and tool-reduced fastening of the gearing assembly on the motor support is realized.

In a preferred development, the motor support, in the region of the at least one latching location, has at least one deformable (joining) pin which, in the deformed state, blocks or at least counteracts any detaching of the latching connections. Herein, the gearing assembly is fixed in the motor support by latching tabs or clips. In the region of the latching tabs/clips, pins are pressed into the motor support to, for example, prevent the latching tabs/clips from bending open, and to reduce any clearance of the connection between the gearing and the motor support caused by structural part tolerances. These pins are preferably already molded or injection-molded onto the motor support and need only be pressed in or deformed for fixing.

In a preferred application, the motor support is disposed in the manner of a crossbar between two rail arrangements of the seat adjustment. For this application, the gearing assembly is disposed on the motor support, wherein the motor support is fastened to both rail arrangements. Herein, the gearwheel has at least one flex shaft interface. In particular, the gearwheel has two flex shaft interfaces and is herein drivingly coupled to two flex shafts extending towards the rail arrangements. Herein, the flex shafts are each coupled, on the one hand, to the gearwheel and, on the other hand, to an adjusting gear, in particular to a spindle gear, associated with the respective rail arrangement. Herein, the flex shafts project out of the gearwheel receptacle on both sides. This means that the longitudinal direction of the gearwheel receptacle is orientated in a lateral direction relative to the rail arrangements. Herein, the gear cover has a central guide-through opening for the flex shaft.

The vehicle seat according to the invention is configured, for example, as a front seat or as a driver's seat of a motor vehicle. Herein, the vehicle seat has a seat adjustment as described above. As a result, the vehicle seat is produceable in a particularly simple and cost-effective manner.

Other features which are considered as characteristic for the invention are set forth in the appended claims.

Although the invention is illustrated and described herein as embodied in a method for producing a seat adjustment for a vehicle, a gear cover, a seat adjustment and a vehicle seat, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a side-elevational view of a vehicle seat with a seat longitudinal adjustment;

FIG. 2 is a perspective view of a gearing assembly and of a motor support of the seat longitudinal adjustment;

FIG. 3 is a perspective view of the gearing assembly;

FIG. 4 is a perspective exploded view of the gearing assembly;

FIG. 5 is a perspective view of a gear housing of the gearing assembly;

FIG. 6 is a perspective view of a gear cover for the gear housing with a view of an exterior;

FIG. 7 is a perspective view of the gear cover with a view of an interior;

FIG. 8 is a perspective view of the gearing assembly and the motor support in a disassembled state;

FIG. 9 is a perspective view of a gear receptacle of the motor support;

FIG. 10 is a plan view of the gearing assembly and the motor support in a disassembled state;

FIG. 11 is a plan view of the gearing assembly and the motor support in a joined state; and

FIG. 12 is a partial perspective sectional view of the gearing assembly and the motor support in a joined state.

### DETAILED DESCRIPTION OF THE INVENTION

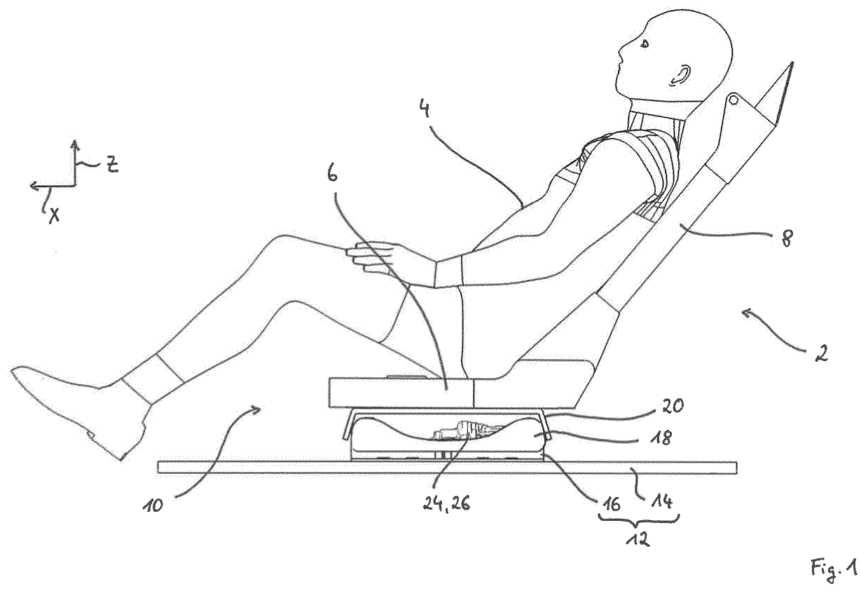

Referring now in detail to the figures of the drawings, in which parts and sizes corresponding to one another are provided with the same reference numerals throughout, and first, particularly, to FIG. 1 thereof, there is seen a shell of a vehicle seat 2 without seat cushions and without a seat cover, in which a vehicle user 4 is seated thereon. The vehicle seat 2 has a seat part 6 and a tiltable seat back (backrest) 8. In FIG. 1, the vehicle seat 2 is depicted in a reclined position with the seat back 8 inclined backwards.

Below, data regarding the spatial directions is also indicated, in particular, in a coordinate system of the motor vehicle (vehicle coordinate system) regarding an exemplary installed situation of a vehicle front seat, for example of a driver's seat. Herein, the abscissa axis (X-axis, X-direction) is orientated along the vehicle longitudinal direction (direction of travel), and the ordinate axis (Y-axis, Y-direction) is orientated along the vehicle lateral direction, and the applicate axis (Z-axis, Z-direction) is orientated along the vehicle height.

The vehicle seat 2 has a bottom assembly in the form of an electromotive seat longitudinal adjustment (seat adjustment) 10. The seat longitudinal adjustment 10 has two rail arrangements 12 disposed in parallel to the sides of the seat.

Herein, each rail arrangement 12 has a lower rail 14 configured as a long rail and an upper rail 16 bearing-mounted therein so as to be displaceable. In the assembled state, the lower rail 14 is established at a vehicle bottom or a vehicle shell of the motor vehicle, wherein the upper rail 16 is coupled to a seat base 20 of the seat part 6 via an upper rail retaining bracket 18. The seat base 20 can also be configured, for example, with a seat height adjustment.

In the assembled or installed state, the lower rails 14 are orientated with a horizontal rail longitudinal direction parallel to the vehicle longitudinal direction (X), wherein the upper rails 16 are disposed so as to be displaceable (linearly) along the rail longitudinal direction.

The upper rail retaining brackets 18 of the two upper rails 16 are joined to a motor support 22 (FIG. 2) orientated in the Y-direction.

As depicted in FIG. 2, for example, a gearing assembly 24 with an electric motor 26 as a (seat) adjusting motor is disposed on the motor support 22. In the lower rails 14, for example, a respective spindle gear is integrated as an adjusting gear for the seat longitudinal adjustment 10. Herein, the spindle gears each have a spindle extending along the respective lower rail 14 and a spindle nut. The spindle nuts are drivingly coupled to the gearing assembly 24 or to the electric motor 26 via a respective flex shaft 28. Herein, the flex shafts 28 are guided in a shaft or guide channel of the motor support 22, not shown in more detail.

The motor support 22 has one flange collar 30 each on its end faces for fastening to the upper rail retaining brackets 18.

The construction of the gearing assembly 24 is explained in more detail below with reference to FIGS. 3 to 7 and 12.

The brushless electric motor 26 is configured, for example, as an external rotor with a wound stator 32 and a rotor (pot) 36 provided with permanent magnets 34. The rotor 36 is joined to a motor shaft 38 in a manner fixed to the shaft. A helical worm shaft 40 for driving a gearwheel 42 coupled to the flex shafts 28 is disposed on the motor shaft 38. The motor shaft 38 is rotatably bearing-mounted in a bearing seat 50 of a gear housing 52 by using bearings 44, 46, 48.

The electric motor 26 is connected to motor electronics which are disposed in an installation space formed between an electronics support 54 and an electronics cover 56. The electronics support 54 is disposed on an end face of the electric motor 26 opposite the worm shaft 40.

The obliquely toothed gearwheel 42 is disposed on a gear shaft 58 in a manner fixed to the shaft, wherein the gear shaft 58 has, at either end of the shaft, one receptacle 60 each for coupling to the respective flex shaft 28 in a rotationally fixed manner.

The gear housing 52 depicted individually in FIG. 5 has a motor receptacle 62 for at least partially receiving the electric motor 26. The approximately pot-shaped motor receptacle 62 opens into an approximately tubular coupling section 64 which opens into the bearing seat 50. Herein, the motor receptacle 62, the coupling section 64 and the bearing seat 50 are disposed coaxially relative to one another. Laterally to the coupling section 64, a cylindrical gearwheel receptacle 66 is molded on as a single piece, that is, integrally (in one piece) or monolithically, for enclosing the gearwheel 42. Herein, the coupling section 64 and the gearwheel receptacle 66 or the volume enclosed thereby are interconnected by a window-like guide-through opening 68 (FIG. 12).

The electric motor 26 sits in a motor housing 70 connected to the electronics support 54 and the electronics cover 56 which surrounds the electric motor 26 on the outer circumference. Herein, the electric motor 26 is plugged into the motor receptacle 62 so that a collar of the motor receptacle 62 is brought into abutment with the motor housing 70. In the plugged-in state, the motor shaft 38 engages the bearings 44, 46, 48 disposed on the bearing seat 50 at either end of the shaft, wherein the worm shaft 40 is disposed in the coupling section 64 in such a manner that the worm shaft 40 and the gearwheel 42 are in meshing engagement with one another through the guide-through opening 68.

The gearwheel receptacle 66 is pot-shaped with a bottom configured as a bearing seat 72. The gearwheel receptacle 66 is thus opened on one side, wherein the opening is closable by a gear cover 74. Herein, the gear cover 74 has a bearing seat 76 (FIG. 7). In each of the bearing seats 72, 76, a bearing 78 is disposed for rotatably mounting the gear shaft 58, wherein FIG. 4 shows only the bearing 78 on the cover side.

A retaining frame 80 with a retaining collar 82 projecting upwards on both sides along the gearwheel receptacle longitudinal direction is molded onto the gearwheel receptacle 66. On the front side, facing the bearing seat 50, the retaining frame 80 has a receptacle 84 for a joining pin 86. On the opposite rear side, facing the motor receptacle 62, the retaining frame 80 has a latching lug 88 projecting perpendicularly upwards from the retaining collar 82. The latching lug 88 is thus orientated perpendicularly to the axial directions of the motor shaft 38 and of the gear shaft 58.

The gear cover 74 depicted individually in FIGS. 6 and 7 has a plug-in collar 90 enclosing the bearing seat 76 which is inserted into the opening of the gearwheel receptacle 66 for assembly. The plug-in collar 90 has a number of radially raised scraper ribs as fastening devices 92 which in the figures are provided with reference numerals only by way of example. The gear cover 74 has a central guide-through opening 94 for the flex shaft 28. At approximately half the height, the gear cover 74 has a collar 96 projecting radially upwards as an axial stop during plug-in assembly on the gearwheel receptacle 66.

Herein, for prefixing on the gear housing 52, the gear cover 74 is also pressable into the gearwheel receptacle 66, wherein the scraper ribs 92 realize an in particular force-locking clamping fastening of the gear cover 74 on the gearwheel receptacle 66.

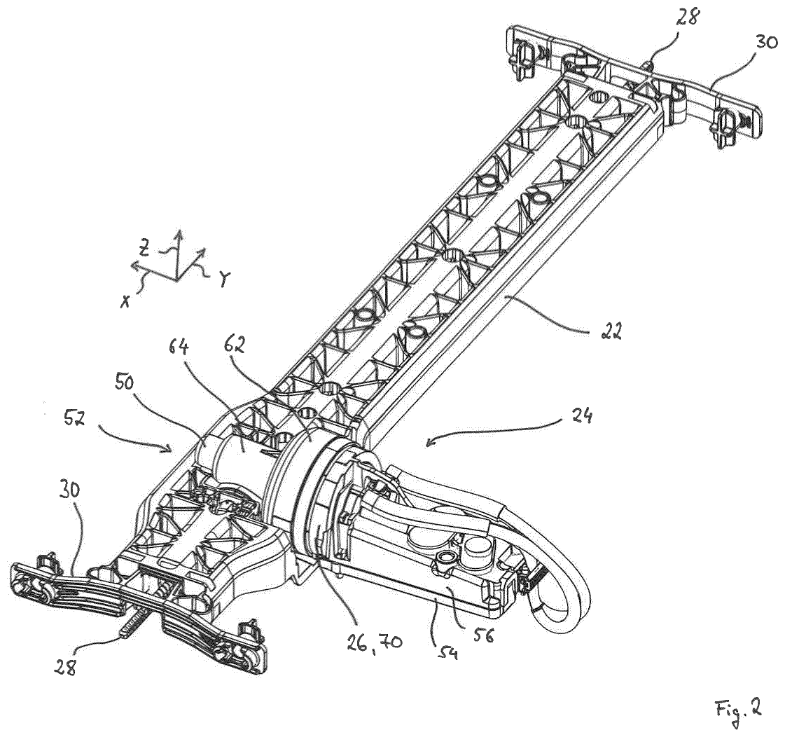

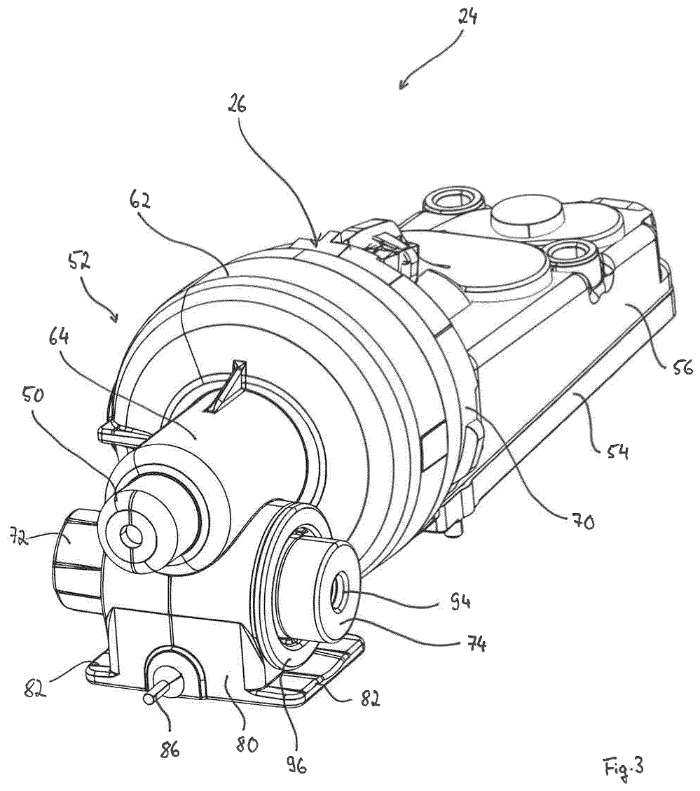

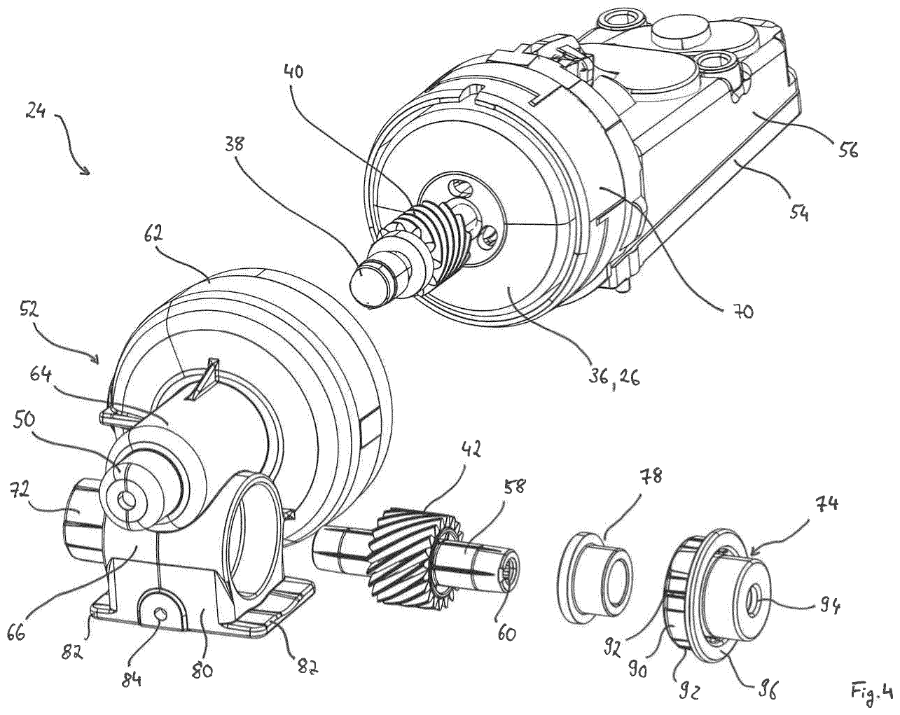

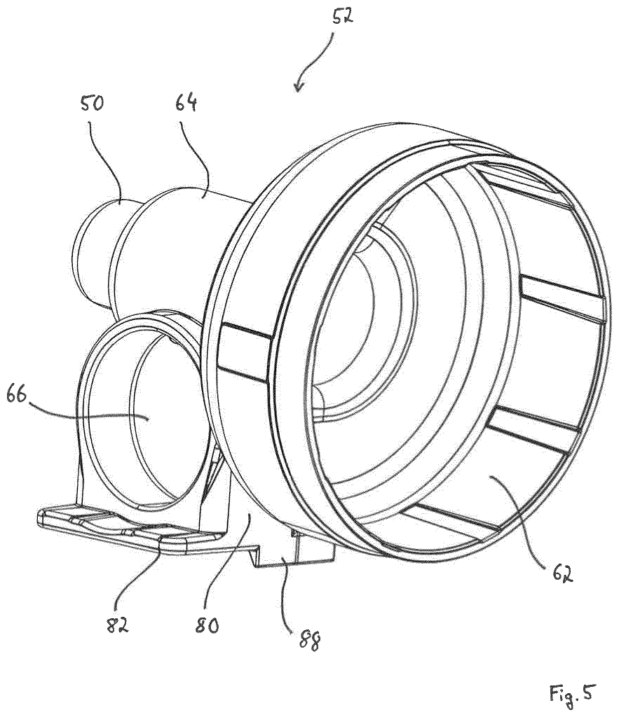

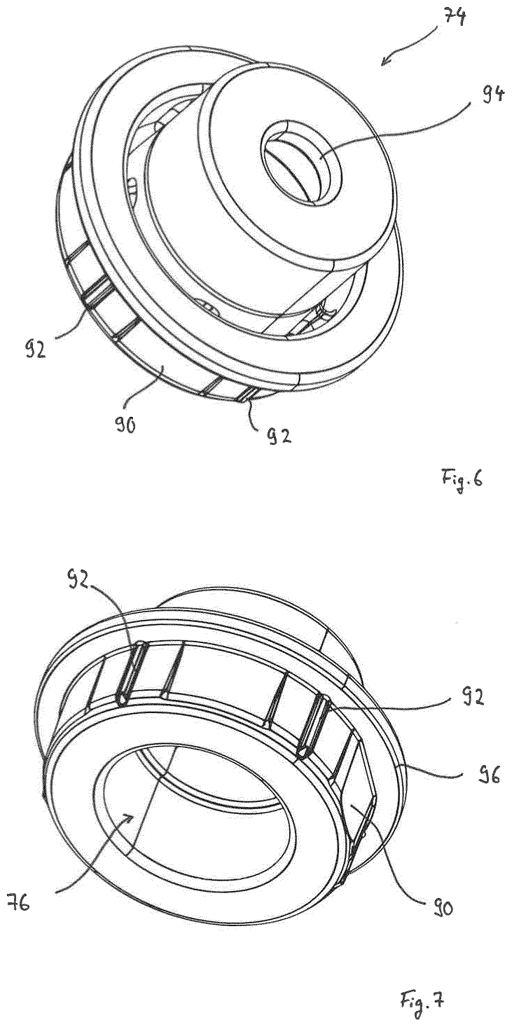

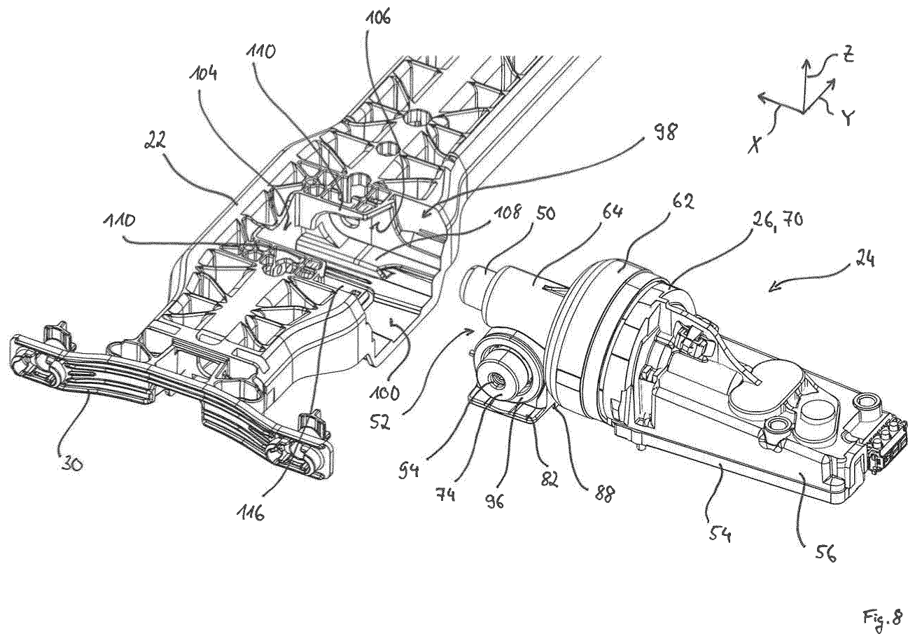

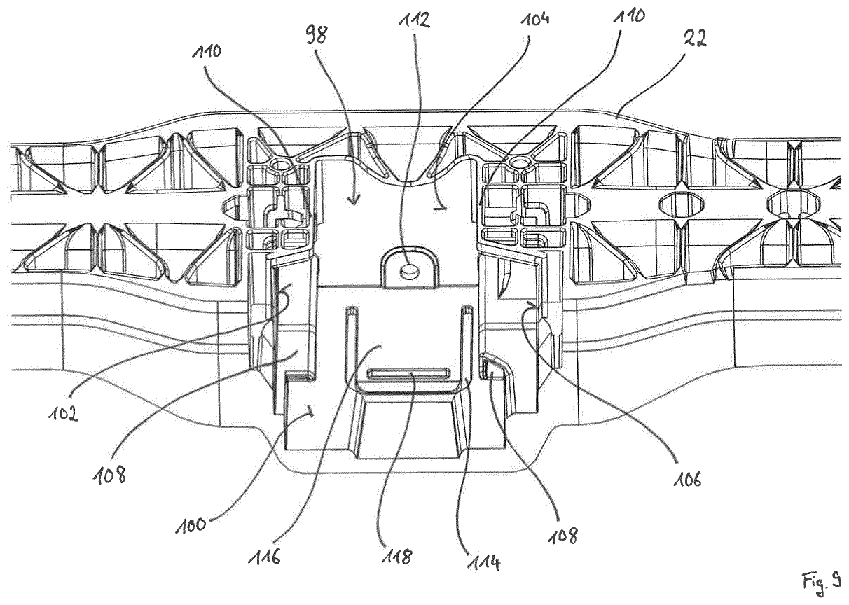

As can be seen comparatively clearly in FIGS. 8 and 9, the motor support 22, which is of truss-like configuration, has a gear receptacle 98 for retention of the gearing assembly 24. Herein, the gear receptacle 98 is in particular configured for form-locking and/or force-locking fastening and retention of the gear housing 52. The construction of the gear receptacle 98 is explained in more detail below, in particular with reference to FIG. 9.

The gear receptacle 98 has an approximately rectangular bottom 100 and three side walls 102, 104, 106 extending perpendicularly therefrom. In the joined state, the side walls 102, 106, which are disposed in parallel to one another, are disposed on the end face of the gearwheel receptacle 66 and each have an opening, not shown in more detail, in the associated channel for guiding the flex shafts 28.

Two outriggers 108, 110 molded on perpendicularly extend from the side walls 102, 106 and project into the gear receptacle 98. Herein, the outriggers 108 are disposed close to the bottom 100, wherein the outriggers 110 are disposed at an upper end of the side walls 102, 106. A groove-like intermediate space for guiding the retaining collar 82 is formed between the bottom 100 and the outriggers 108, wherein the intermediate space formed between the outriggers 108, 106 is provided and formed for receiving and guiding the gearwheel receptacle 66.

In the side wall 104 orientated perpendicularly to the side walls 102, 106 and at the end face to the bearing seat 50, a guide-through opening 112 is introduced at the bottom, which in the joined state is disposed coaxially aligned with the receptacle 84 of the retaining frame 80.

In the bottom 100, a U-shaped slot 114 is introduced which exposes or forms a bendably flexible latching tab 116. The latching tab 116 has a receptacle opening 118 for the latching lug 88 at its free end.

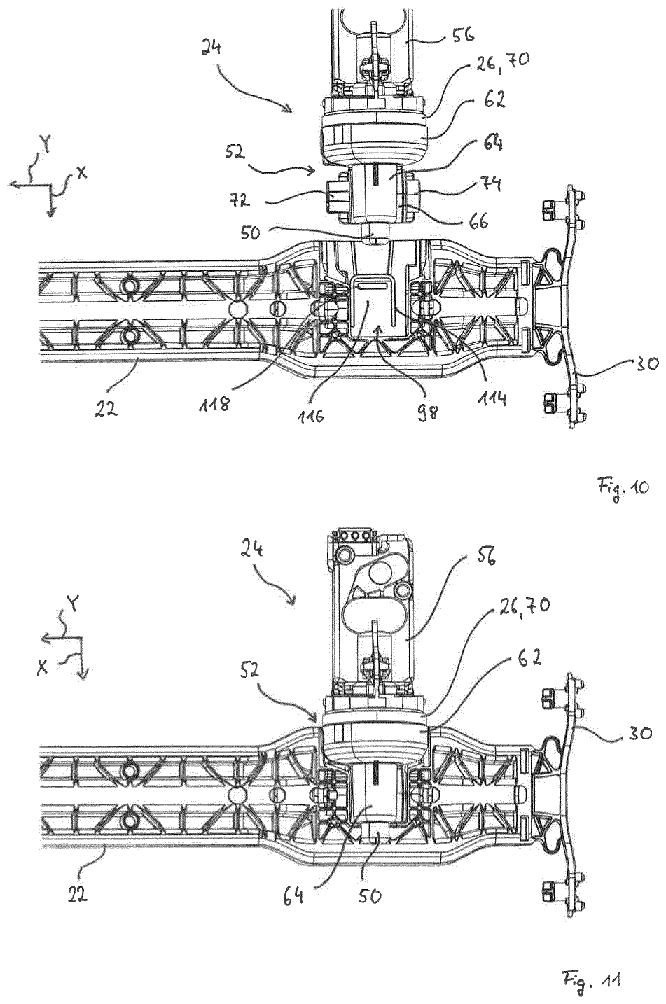

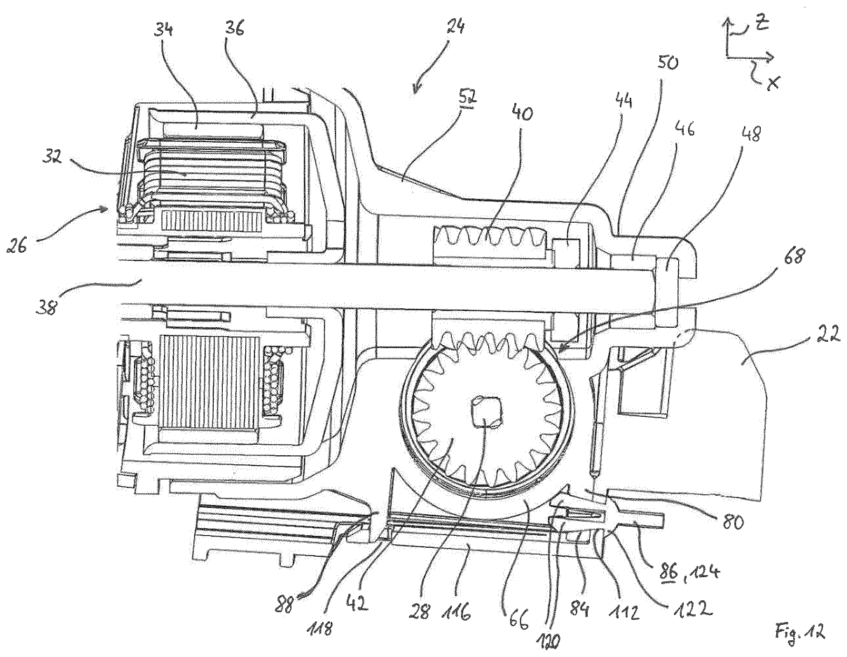

With reference to FIGS. 10 and 12, a method according to the invention for producing the seat longitudinal adjustment 10, in particular for joining the gearing assembly 24 and the motor support 22, is explained in more detail below.

First, the gearing assembly 24 is assembled. Herein, the electronics support 54 and the electronics cover 56 are joined to the electric motor 26, and the latter is inserted into the motor receptacle 62 of the gear housing 52 by using the motor shaft 38 in such a manner that the worm shaft 40 is disposed in the coupling section 64. The gearwheel 42 is inserted into the gearwheel receptacle 66 by using the gear shaft 58 so that the gearwheel 42 is in meshing engagement with the worm shaft 40.

According to the method, the gear cover 74 is merely prefixed on the gearwheel receptacle 66. For this purpose, the gear cover 74 is pressed into the opening of the gearwheel receptacle 66 by using the scraper ribs 92. The joint connection realized by the prefixing is sized regarding its stability, in particular only regarding transport and gear assembly, so as to prevent the gearwheel 42 from falling or sliding out of the gearwheel receptacle 66 which is undesired. The prefixed joint connection between the gear cover 74 and the gearwheel receptacle 66 is itself not provided or suitable for operating the gearing assembly 24 under load.

Subsequently, the gearing assembly 24 is slid into the gear receptacle 98 in the X-direction, as depicted in FIG. 10. Herein, the retaining collar 82 engages the guide formed by the bottom 100 and the outriggers 108, wherein the bearing seat 72 and the gear cover 74 are guided linearly between the outriggers 108, 110. Herein, the outriggers 108, 110 realize form-locking guides in the Z-direction so that the latching lug 88 deflects the latching tab 116 at least partially when sliding in the gearing assembly 24, and subsequently latches or clips into the receptacle opening 118 in a form-locking and force-locking manner. By using the latching or clipping, the gearing assembly 24 is retained in the gear receptacle 98 in the X-direction in a form-locking manner, wherein the outriggers 108, 110 and the bottom realize a form lock in the Z-direction, and wherein the side walls 102, 106 enclose the gearing assembly 24 in the X-direction in a form-locking manner. In particular, the gear cover 74 is thus retained on the gearwheel receptacle 66 by using the motor support 22 in a form-locking manner so that the gearing assembly 24 is reliably operable under (full) load. The motor support 22 thus mechanically prevents the gear cover 74 from being able to be detached from the gearwheel receptacle 66 during operation, that is, under (full) load.

In this embodiment, the motor support 24 has at least one deformable joining pin 86 which is inserted into the guide-through opening 112 and the receptacle 84. Herein, the joining pin 86 is injection-molded, for example, onto the motor support 22. The joining pin 86 has two joining legs 120 passing through the guide-through opening 112 and the receptacle 84, and a collar 122, and also a joining shank 124. After latching the latching lug 88 to the receptacle opening 118, the joining shank 124 is deformed axially towards the joining legs 120. As a result, the joining legs 120 spread open in a dowel-like manner so that form-locking and force-locking fixing of the motor support 22 to the gearing assembly 24 is realized, which counteracts the latching being detached.

Subsequently, the flex shafts 28 are guided through the guide channels of the motor support 22 on both sides and joined to the receptacles 60 of the gear shaft 58. Finally, the motor support 22 is fixed to the upper rail retaining brackets 18 by using the flange collars 30, and the flex shafts 28 are coupled to the respective adjusting gear of the rail arrangement 12.

The claimed invention is not limited to the exemplary embodiments described above. Rather, other variants of the invention can also be derived therefrom by a person skilled in the art within the scope of the disclosed invention without departing from the subject matter of the claimed invention. In particular, further, all the individual features described in connection with the various exemplary embodiments are also combinable in any other way within the scope of the disclosed claims without departing from the subject matter of the claimed invention.

The following is a summary list of reference numerals and the corresponding structure used in the above description of the invention:
2 Vehicle seat
4 Vehicle user
6 Seat part
8 Seat back
10 Seat adjustment, seat longitudinal adjustment
12 Rail arrangement
14 Lower rail
16 Upper rail
18 Upper rail retaining bracket
20 Seat base
22 Motor support
24 Gearing assembly
26 Electric motor
28 Flex shaft
30 Flange collar
32 Stator
34 Permanent magnet
36 Rotor
38 Motor shaft
40 Worm shaft
42 Gearwheel
44, 46, 48 Bearing
50 Bearing seat
52 Gear housing
54 Electronics support
56 Electronics cover
58 Gear shaft
60 Receptacle
62 Motor receptacle
64 Coupling section
66 Gearwheel receptacle
68 Guide-through opening
70 Motor housing
72 Bearing seat
74 Gear cover
76 Bearing seat
78 Bearing
80 Retaining frame
82 Retaining collar
84 Receptacle
86 Joining pin
88 Latching lug
90 Plug-in collar
92 Fastening devices/scraper ribs
94 Guide-through opening
96 Collar
98 Gear receptacle
100 Bottom
102, 104, 106 Side wall
108, 110 Outrigger
112 Guide-through opening
114 Slot
116 Latching tab
118 Receptacle opening
120 Joining leg
122 Collar
124 Joining shank
X Vehicle longitudinal direction
Y Vehicle lateral direction
Z Vehicle height direction

1. A method for producing a seat adjustment for a vehicle seat, the method comprising:
providing the vehicle seat, the vehicle seat having a gearing assembly including an electric motor, a gearwheel, a gear housing having a motor receptacle for receiving the electric motor and a cylindrical gearwheel receptacle for enclosing the gearwheel, and a gear cover for closing the gearwheel receptacle;
prefixing the gear cover on the gearwheel receptacle during assembly of the gearing assembly;
subsequently mounting the gearing assembly in a motor support causing the gearing assembly to sit at least in sections in the motor support; and
using the motor support to mechanically prevent the gear cover from being able to be detached from the gearwheel receptacle during operation.

2. The method according to claim 1, which further comprises at least one of form-lockingly or force-lockingly prefixing the gear cover in the gearwheel receptacle.

3. A gear cover for a gearing assembly of a seat adjustment, the gear cover comprising fastening devices for prefixing the gear cover on a gearwheel receptacle of the gearing assembly.

4. The gear cover according to claim 3, wherein the fastening devices are configured for at least one of form-locking or force-locking plug-in assembly with the gearwheel receptacle.

5. The gear cover according to claim 3, which further comprises a plug-in collar for plugging into the gearwheel receptacle, the fastening devices being scraper ribs molded onto the plug-in collar and projecting radially upwards.

6. A seat adjustment for a vehicle seat, the seat adjustment comprising:
a motor support;
a gearing assembly including an electric motor, a gearwheel and a gear housing having a motor receptacle for receiving the electric motor and a cylindrical gearwheel receptacle for enclosing the gearwheel, and the gear cover according to claim 3 for closing the gearwheel receptacle;
the gear cover being prefixed on the gearwheel receptacle;
the gearing assembly sitting at least in sections in the motor support; and
the motor support mechanically preventing the gear cover from being able to be detached from the gearwheel receptacle during operation.

7. The seat adjustment according to claim 6, wherein the motor support has a gear receptacle for the gearing assembly, the gearing assembly being disposed at least in sections in the gear receptacle for form-lockingly fixing the gear cover to the gearwheel receptacle.

8. The seat adjustment according to claim 6, wherein the gearing assembly or the gear housing is at least one of form-lockingly or force-lockingly fastened to the motor support.

9. The seat adjustment according to claim 6, wherein the gearing assembly or the gear housing is latched to the motor support.

10. The seat adjustment according to claim 9, wherein the gear housing is latched to the motor support in at least one latching location, the motor support has at least one deformable joining pin in a region of the at least one latching location, and the at least one deformable joining pin, in a deformed state, counteracts any detaching of the latching connection.

11. The seat adjustment according to claim 6, which further comprises two flex shafts projecting out of the gearwheel receptacle at two sides, the gearwheel being drivingly coupled to the two flex shafts.

12. A vehicle seat for a motor vehicle, the vehicle seat comprising the seat adjustment according to claim 6.
